(19) United States
(12) Patent Application Publication
(10) Pub. No.: US 2014/0019952 A1
(43) Pub. Date: Jan. 16, 2014

(54) SECURE METHOD OF ENFORCING CLIENT CODE VERSION UPGRADE IN DIGITAL RIGHTS MANAGEMENT SYSTEM

(71) Applicants: Rafie Shamsaasef, San Diego, CA (US); Paul Moroney, La Jolla, CA (US)

(72) Inventors: Rafie Shamsaasef, San Diego, CA (US); Paul Moroney, La Jolla, CA (US)

(73) Assignee: GENERAL INSTRUMENT CORPORATION, Horsham, PA (US)

(21) Appl. No.: 13/545,921

(22) Filed: Jul. 10, 2012

(51) Int. Cl. G06F 9/44

(52) U.S. Cl. 717/170

(57) ABSTRACT

A method for enforcing a software upgrade for software operable on a device includes receiving, at the device, a message including software-version information for the software from a domain controller. The software-version information indicates a list of approved versions of the software. The method includes determining, by the device, the software-version information from the message, and determining a current version of the software included on the device by performing a comparison of versions in the list of approved versions to the current version of the software on the device. If the current version of the software is not included in the list of approved versions, the method includes causing the device to not have or use a set of up-to-date security credentials for a set of content servers, for accessing any pieces of media on the set of content servers until the device has an approved version of the software.

### BACKGROUND

Particular embodiments generally relate to version management of a software application.

Media devices typically include decoders that decode media so that the media may be consumed by the media device or may be consumed by another device to which the media device provides the decoded media. Typical media, which is decoded and consumed by a media device, may include television programs, movies, music, etc. Media devices may include set-top-boxes (STBs), personal video recorders (PVRs), televisions, computing devices (e.g., personal computers, tablet computers, etc.), mobile-media devices (e.g., smartphones, personal digital assistants (PDAs), etc.), etc. The media may be streamed to a media device for decoding and consumption, or may be downloaded and then stored as a file for decoding and consumption.

A media device often stores and operates a software application that controls the media device to decode and consume media. The software application further includes security features to permit or inhibit the decrypting of media. For example, media cannot be decrypted if the media device fails to authenticate with a domain controller to acquire a service ticket or if the service ticket has expired. A service ticket is used in authenticating the media device to a content server, and thus when the service ticket is expired (or does not exist), the media device is not allowed to collect key material to decode and consume media from the content server. The key material includes information for deriving a content key of the media. The software application also typically includes security features to inhibit the copying of media from an authenticated and authorized media device to a non-authorized media device.

The software application is revised for various purposes, such as updating the software application's security features. The software application has an assigned version where the version indicates various changes to the software application, such as the updated security features. There is a concern that a media device that is authorized to receive, decode, and consume media has a latest version of the software application, which has the latest version of security features, and not an outdated version. Security features are often defeated by people intent on fraudulently copying media. Thus, updated versions of the software are released with updated security features that replace older security features that may already be defeated or otherwise are determined to have faults that make the security features vulnerable to being defeated.

### SUMMARY

In one embodiment, a method for enforcing a device software upgrade for software operable on a device includes receiving, at the device, a message including software-version information for the software from a domain controller. The software-version information indicates a list of approved versions of the software. The method further includes determining, by the device, the software-version information from the message, and determining a current version of the software included on the device. The method further includes performing a comparison, by the device, of versions in the list of approved versions to the current version of the software on the device. If the current version of the software is not included in the list of approved versions, the method includes further causing the device to not have or use a set of up-to-date security credentials for a set of content servers, for accessing any pieces of media on the set of content servers until the device has an approved version of the software.

In another embodiment, a non-transitory computer-readable storage medium comprises instructions for enforcing a device software upgrade for software operable on a device. The instructions are for controlling the device to be operable for: receiving, at the device, a message including software-version information for the software from a domain controller, wherein the software-version information indicates a list of approved versions of the software; determining, by the device, the software-version information from the message; determining a current version of the software included on the device; performing a comparison, by the device, of versions in the list of approved versions to the current version of the software on the device; if the current version of the software is not included in the list of approved versions, causing the device to not have or use a set of up-to-date security credentials for a set of content servers, for accessing any pieces of media on the set of content servers until the device has an approved version of the software.

In another embodiment, a device configured for enforcing a device software upgrade for software operable on the device includes one or more computer processors, and a computer-readable storage medium, which includes instructions for controlling the one or more computer processors to be operable for: receiving, at the device, a message including software-version information for the software from a domain controller, wherein the software-version information indicates a list of approved versions of the software; determining, by the device, the software-version information from the message; determining a current version of the software included on the device; performing a comparison, by the device, of versions in the list of approved versions to the current version of the software on the device; and if the current version of the software is not included in the list of approved versions, causing the device to not have or use a set of up-to-date security credentials for a set of content servers, for accessing any pieces of media on the set of content servers until the device has an approved version of the software.

In another embodiment, a method for a server triggering a device software upgrade for software operable on the device includes receiving, at the server, a first message from the device, and transmitting, from the server, a second message including software-version information for the software to the device based on receiving the first message. The software-version information includes a list of approved versions of the software. The method further includes receiving, at the server, a request for an updated security credential for accessing a content server for retrieving a piece of media if one of the approved versions in the list of approved versions matches a current version of the software on the device.

The following detailed description and accompanying drawings provide a more detailed understanding of the nature and advantages of the present invention.

### BRIEF DESCRIPTION OF THE DRAWINGS

FIG. 1 depicts an example of a media system according to one embodiment.

FIG. 2 depicts a high-level flow diagram of a method for triggering a device to retrieve a latest version of software if a current version of the software is earlier than the latest version of the software.

FIG. 3 depicts a more detailed example of the software version manager according to one embodiment.

### DETAILED DESCRIPTION

Described herein are techniques for managing a software application (software) that operates on a device to provide that the software is an approved version. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

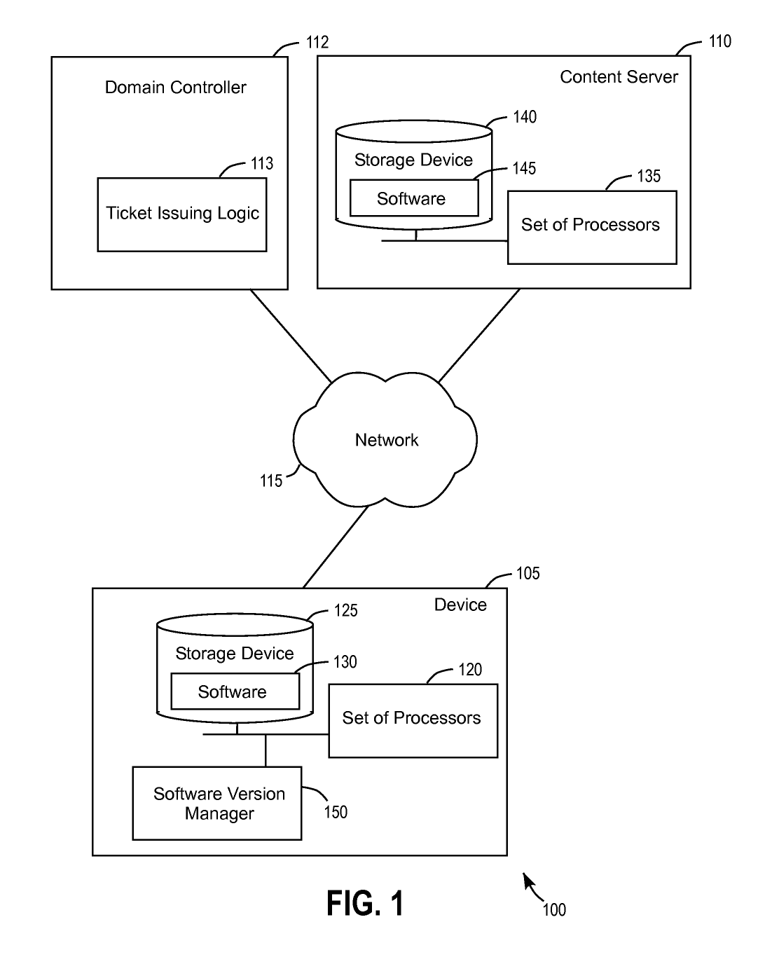

FIG. 1 depicts an example of a media system 100 according to one embodiment. Media system 100 includes a device 105 a content server 110, a domain controller 112, and a network 115. Device 105 may receive media from content server 110 via network 115, and may decode and consume the media. Device 105 may include a set of processors 120 and a storage device 125. Storage device 125 may store software 130, which may be supplied from storage device 125 to set of processors 120 for execution. Software 130 may operate on set of processors 120 to control set of processors 120 for decoding and consuming media. For example, software 130 may be included in a media player or media streaming software. Storage device 125 may also store media, which may be decoded and consumed by set of processors 120. Consumption of media may include the playback of media on device 105. Media as referred to herein may include video media, which may include audio tracks, such as television programs, movies, etc. Media as referred to herein may also include audio media, such as music media, audio books, audio lectures, etc. Domain controller 112 is a server device having server ticket issuing logic 113 that responds to security authentication requests and issues server tickets to device 105 to access content server 110.

As described briefly above, device 105 may be a media device, and according to various specific embodiments, device 105 includes a set-top-box (STB), a personal video recorder (PVR), a television, a computing device (e.g., a personal computer, a tablet computer, etc.), or a mobile-media device (e.g., a smartphone, a personal digital assistant (PDAs). It will be understood that device 105 is not limited to the foregoing described example embodiments.

Content server 110 may be a computing device that operates a server operating system. Content server 110 may alternatively include a home gateway device, a home media server, a STB, a PVR, a video on demand (VOD) server, etc. Content server 110 may include a set of processors 135 and a storage device 140. Storage device 140 may store software 145, which may be supplied from storage device 140 to set of processors 135 for execution. Software 145 may be used to serve content to device 105. While media system 100 is shown in FIG. 1 as including one content server 110, media system 100 may include a number of content servers configured to provide media to device 105.

Network 115 may include a variety of networks used for communications between device 105 and content server 110. For example, network 115 may include the Internet. Network 115 may include one or more intranets. The one or more intranets may include a home network, which may include device 105, content server 110, domain controller 112, and/or other devices.

Software 130 on device 105 may be associated with a software version. For example, as discussed above, a software application is revised for various purposes, and each revision may result in a new version. If device 105 does not include an approved version of software 130 (e.g., not the latest version), particular embodiments provide a process to ensure that device 105 is not allowed to decode (or retrieve) media from content server 110.

In one embodiment, content server 110 includes a list of approved software versions, which may be a list of versions for all supported types of devices 105 (e.g., devices that run different operating systems). The list may be included in a part of a message, such as in an encrypted data part, sent to device 105. A software version manager 150 of device 105 then verifies if a current version of software 130 is on the list. Software version manager 150 then enforces whether device 105 can decode media from content server 110 based on the comparison.

Device 105 cannot accept key material to decrypt, decode, and consume media from content server 110 until software 130 is upgraded to a version on the list. Accordingly, particular embodiments allow device 105 to enforce the requirement that the software version be upgraded. By tying the service ticket to the upgrade, device 105 is forced to upgrade before being able to retrieve media. This offloads the requirement of content server 110 of having to verify if device 105 has an approved version of software 130 to device 105. Key material includes, or is used for deriving, a content key that allows device 105 to decrypt a piece of media. The key material is sometimes referred to as a pre-key if the key material is used to derive the content key.

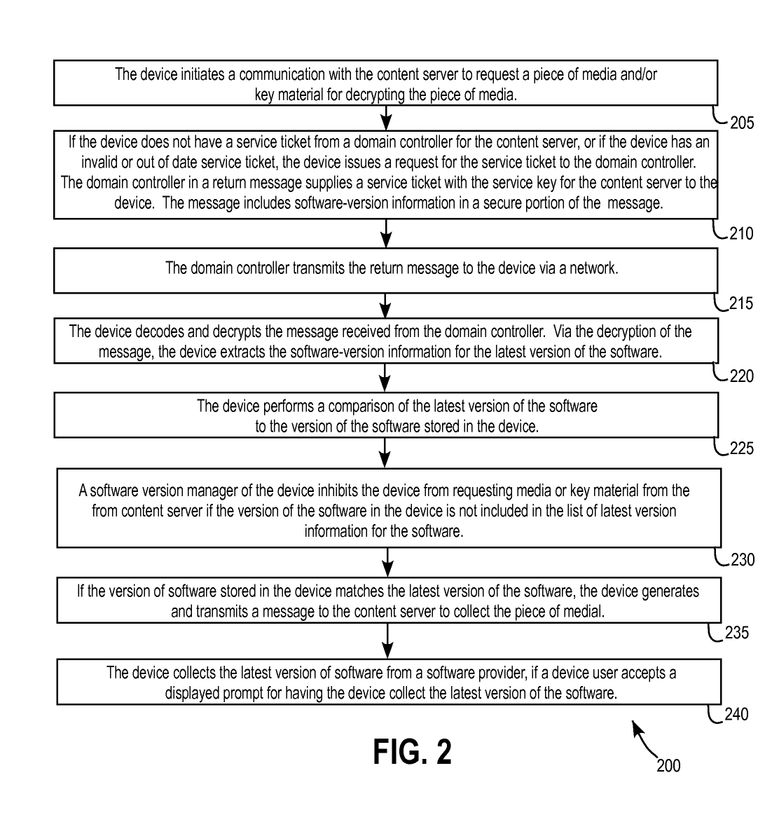

FIG. 2 depicts a high-level flow diagram of a method 200 for triggering device 105 to retrieve an approved version of software 130. Method 200 may be executed if device 105 attempts to use software 130 to retrieve media from content server 110, or attempts to use software 130 to consume media previously retrieved. Device 105 should have a valid service ticket from domain controller 112 to retrieve media from content server 110. If media system 100 includes a number of content servers, device 105 should have a service ticket from domain controller 112 for each content server. If media system 100 includes one content server, the functions of content server 110 and domain controller 112 may be combined into a single server, which may be referred to as a content server. The high-level flow diagram is exemplary and those of skill in the art will understand that various steps of the high-level flow diagram may be combined and/or added without deviating from the scope and the purview of the embodiment.

At 205, device 105 initiates a communication with content server 110 to request a piece of media. If device 105 does not have a service ticket for content server 110 or has an invalid or out of date service ticket, the request for media will fail.

At 210, if device 105 does not have a service ticket from domain controller 112 for content server 110, or if device 105 has an invalid or out of date service ticket, device 105 issues a request for the service ticket to domain controller 112 according to one embodiment. Domain controller 112 in a return message (“message”) may supply a service ticket with the service key (which device 105 may use to sign messages sent to content server 110) for content server 110 to device 105. The message may include a number of service tickets if media system 100 includes a number of content servers, and the service tickets may be respectively for accessing the number of content servers. For example, device 105 may not have a service ticket if device 105 tries to use software 130 for a first time and has not previously retrieved the service ticket from domain controller 112. For example, if device 105 has downloaded software 130 from a server for a first time, or has loaded software 130 from a local storage medium, such as a compact disk (CD) for a first time, device 105 may not have a service ticket from domain controller 112 for accessing content server 110.

The communication of the request for the service ticket may be transmitted from device 105 to domain controller 112 via a secure communication protocol, such as the internet protocol rights management (IPRM) protocol of Motorola. The request may be a ticket-granting server (TGS) request (e.g., for issuing service tickets for specific services) or an authentication service (AS) request (e.g., for authentication of a device, such as device 105 and granting of a service ticket). Secure information (e.g., keys) is used to authenticate device 105 to allow media and key material for the media to be retrieved from content server 110. For example, a valid service ticket permits the retrieval of media and key material from content server 110 and permits software 130 to use the key material for the media for decrypting, decoding, and/or consuming the media. An invalid service ticket does not permit device 105 to access content server 110 to retrieve media or key material for decrypting the media from content server 110, and thereby does not permit software 130 to decrypt, decode, and consume media. The service ticket may be any information that is used to authenticate device 105 to allow media or key material to be retrieved from content server 110.

Domain controller 112 may insert software-version information for software 130 into the message. The software-version information may be inserted into an encrypted-data portion of the message. According to one embodiment, the software-version information indicates a latest (or current) version of software 130 that is allowed to retrieve media from content server 110. A version of software 130 may be a number, or the like, that is incremented each time software 130 is revised. Software 130 may be revised to include new security features to inhibit copying of media to an un-authorized device that is not authorized to retrieve media from content server 110 and is not authorized to decode and consume media provided by content server 110.

According to one embodiment, the software-version information is for types of devices (e.g., all of the types of devices) that are authorized to retrieve media from content server 110, and decode and/or consume media retrieved from content server 110. The software-version information may also include a list of latest-version information for software 130 operable on the types of devices.

Device 105 may store the software-version information for a version of software 130, which is stored on device 105. The software-version information of software 130 stored on device 105 may be obfuscated or otherwise protected from user tampering in software 130 by a obfuscating approach so that the software-version information may be substantially secured from tampering by un-authorized devices or the like. Various obfuscating approaches may be provided by various technologies, such as the cloakware of Irdeto B.V.

At 215, domain controller 112 transmits the message generated at 210 to device 105, which receives the message from network 115. In one embodiment, the message may be an AS-reply or a TGS-reply. It is noted that a plurality of devices requesting content, as described above, may receive the same message to provide that the plurality of devices, as well as device 105, retrieves a latest version of software 130 as described further below.

At 220, device 105 decodes and decrypts the message received from content server 110. Device 105 may use a device certificate for decrypting the message. Via decryption of the message, device 105 extracts the software-version information for the latest version of software 130 from the message, where the software-version information is in the encrypted-data portion of the message or in an authenticated portion of the message requiring verification (e.g., via a key or the like) to access.

At 225, device 105 performs a comparison of the latest version of software 130 to the version of software 130 stored in device 105. The comparison may be a determination of whether a number that represents the latest version of software 130 is larger than a number that represents the version of software 130 stored in device 105.

According to a specific embodiment where device 105 obfuscates the version of software 130 stored in device 105, device 105 reverse obfuscates the version of software 130 stored in storage device 125. The reverse obfuscating may occur prior to the comparison at 225 described immediately above. According to one embodiment the comparison at 225 is also obfuscated by device 105. Computer code stored in device 105 that performs the described obfuscation and reverse obfuscation of the software version, and the comparison at 225 may also be obfuscated. The obfuscating and the reverse obfuscating may be performed according to a variety of technologies. Approaches for obfuscation and reverse obfuscation may be software based or hardware based, such as signed code running in a protected environment. The cloakware cloaking technology from Irdeto is an example of a software based obfuscating technology that may be used to obfuscate the version of software 130. The comparison of the latest version of software 130 to the version of software 130 stored in device 105 may also be obfuscated or otherwise protected from user tampering by computer code stored on device 105. The cloakware cloaking technology from Irdeto may obfuscate the described comparison.

At 230, software version manager 150 inhibits device 105 from requesting media from content server 110 (and/or any other content servers in media system 100 if media system 100 includes a set of content servers configured to provide media to device 105) if the version of software 130 in device 105 is not included in the list of latest version information according to one embodiment (i.e., until device 105 collects a latest version of software 130). Further, software version manger 150 may inhibit device 105 from issuing a key material request to content server 110 if the version of software 130 in device 105 is not included in the list of latest version information according to one embodiment (i.e., until device 105 collects a latest version of software 130).

A content server may change its set of security credentials (e.g., service ticket and server key) each time a new version of software 130 is released and the version of software 130 in device 105 needs to be upgraded. A set of security credential is not limited to including service tickets and server keys as used herein and may include any token that allows secure access to content server 110. Therefore, even if a fraudulent user of device 105 prevents software version manager 150 from requesting a new service ticket, the service ticket transmitted to the content server from device 105 in the device's request for media or key material will be rejected by content server 110 because the service ticket transmitted by device 105 will be invalid or out of date (invalid and out of date are sometimes used interchangeably herein to indicate security credentials that will rejected by content server 110). Therefore, the request issued by device 105 to content server 110 will be rejected by content server 110.

As described briefly above, software version manager 150 may inhibit device 105 from requesting media from content server 110 until device 105 has a latest (or current) version of software 130. According to a further embodiment, software version manager 150 inhibits device 105 from decrypting media stored in device 105 if the version of software 130 in device 105 is not included in the list of approved versions, until device 105 has a latest (or current) version of software 130. Because device 105, via software version manager 150, determines whether to request media or decrypt media, operations at 220 and 225 may be obfuscated (as described above) so that fraudulent users are inhibited from hacking the operations at 220 and 225 so that the fraudulent users are inhibited from fraudulently gaining access to media.

At 235, if the version of software 130 stored in device 105 matches the latest version of software 130 as determined at 225, device 105 generates and transmits a message to content server 110 to collect a piece of media and/or key material for the piece of media. The message may include the latest service ticket of content server 110. It is noted that if the version of software 130 stored in device 105 matches the latest version of software 130 as determined at 225, the service ticket that device 105 has is current because content server has not generated a new service ticket or new server key because a new version of software 130 has not been issued. According to one embodiment, device 105 may collect a service ticket for content server 110 from domain controller 112 prior to trying to collect the piece of media from content server 110. As described above, each time a new version of software 130 is released, content server 110 may change its service ticket and its server key to inhibit fraudulent requests, such as those described above. The message sent from device 105 to content server 110 may be an AS-request or a TGS-request as is in IPRM system. Content server 110 may transmit the piece of media to device 105 based on receipt of the message. At 235, domain controller 112 may transmit key material, in a service ticket or the like, to device 105 so that device 105 may decrypt the piece of media requested, or may decrypt other media stored in device 105.

If software 130 on device 105 is not the latest version, software version manager 150 will be required to retrieve a latest version of software 130 from a software provider prior to retrieving the piece of media and/or the key material for the piece of media from content server 110. A message may be displayed (e.g., by software version manager 150) to a user of device 105 informing the user that device 105 should acquire a latest version of software 130 prior to requesting a piece of media from content server 110 or key material for the piece of media.

At 240, device 105 collects the latest version of software 130 from a software provider. Device 105 may prompt a user, for example, by displaying a message to accept that device 105 collect the latest version of software 130. Device 105 may collect the latest version of software 130 if the user accepts the prompt. Device 105 may thereafter obfuscate the software version information for the latest version of software 130. The software provider may be content server 110 or may be another server. Subsequent to retrieving the latest version of software 130, device 105 may repeat 210, 215, 220, 225, and 235 described above in an attempt to retrieve the piece of media and/or the key material for the piece of media. In this continued embodiment with the repeat of 210, 215, 220, 225, and 235, when 210 is repeated, device 105 requests an updated security credential from domain controller 112 for accessing content server 110 where the version of software 130 in device 105 has been upgraded at 240 to one of the versions of software 130 in the list of latest version information of the software, and where the previous version of software 130 (prior to 240) did not match one of the versions of software in the list of latest version information of the software. Further, in this continued embodiment, software version manager 150 determines that the software version is on the list in the comparison at 225. Thus, at 235, in addition to content server 110 transmitting the piece of media to device 105, content server 110 transmits the key material to device 105. The key material may be transmitted in a secure message, as defined by the IPRM protocol or other digital rights management protocols.

According to an alternative embodiment, device 105 may have a service ticket with a server key issued by domain controller 112, but the service ticket and server key may be invalid or outdated. The service ticket and server key may have been previously used by device 105 for retrieving media from content provider 110. However, a new version of software 130 may have been issued with a latest version later than the version of software 130 on device 105, and content server 110 may have changed its service ticket and its server key in response to the issuance of the latest version of software 130. If device 105 attempts to retrieve media or key material for decrypting media from content server 110, the request for the media or key material will fail because the service ticket and server key issued in the request are invalid or outdated. After device 105 requests the media or key material, the method will proceed as described above at steps 205-235 with domain controller 112 issuing a new service ticket and server key to device 105, issuing an encrypted copy of the list of latest versions of software 130, and with device 105 being required to retrieve a latest version of software 130 prior to being above to collect media and/or key material for decrypting the media.

According to another alternative embodiment described briefly above, device 105 may have a service ticket with a server key issued by domain controller 112, but the service ticket and server key may be invalid or outdated, and device 105 may also have a piece of media stored that a user would like to have played (e.g., decrypted, decoded, and consumed). According to the embodiment, device 105 requests a latest key material from content server 110 for decrypting the piece of media. Device 105 may issue a request to content server 110 with the service ticket and server key that device 105 has for retrieving the latest key material. The request for the key material will fail because the service ticket and server key are invalid or outdated. After device 105 requests new key material from content server 110 and the request fails, the method will proceed as described above at 205-235 with device 105 requesting a new service ticket and server key from domain controller 112. Domain controller 112 will issue a new service ticket and server key to device 105, and send an encrypted copy of the list of latest versions of software 130. Device 105 will be required to retrieve a latest version of software 130 prior to being above to collect the key material for decrypting the media from content server 110.

According to another alternative embodiment described briefly above, device 105 may have a service ticket with a server key issued by domain controller 112, and the service ticket and server key may be invalid or outdated, and device 105 may have previously secured a right to have a piece of media streamed to device 105 from content server 110. Device 105 may issue a request to content server 110 to have the piece of media streamed to device 105 from the content server. The request may include the service ticket and the server key, which are invalid or outdated because a new version of software 130 may have been issued. The request for streaming the piece of media to device 105 will be rejected by content server 110 according to one embodiment. After device 105 requests that content server 110 stream the piece of media and the request is rejected, the method will proceed as described above at 205-235 with device 105 requesting a new service ticket and server key from domain controller 112. Domain controller 112 will issue a new service ticket and server key to device 105, and send an encrypted copy of the list of latest versions of software 130. Device 105 will be required to retrieve a latest version of software 130 prior to being above to collect the key material for decrypting the media from content server 110.

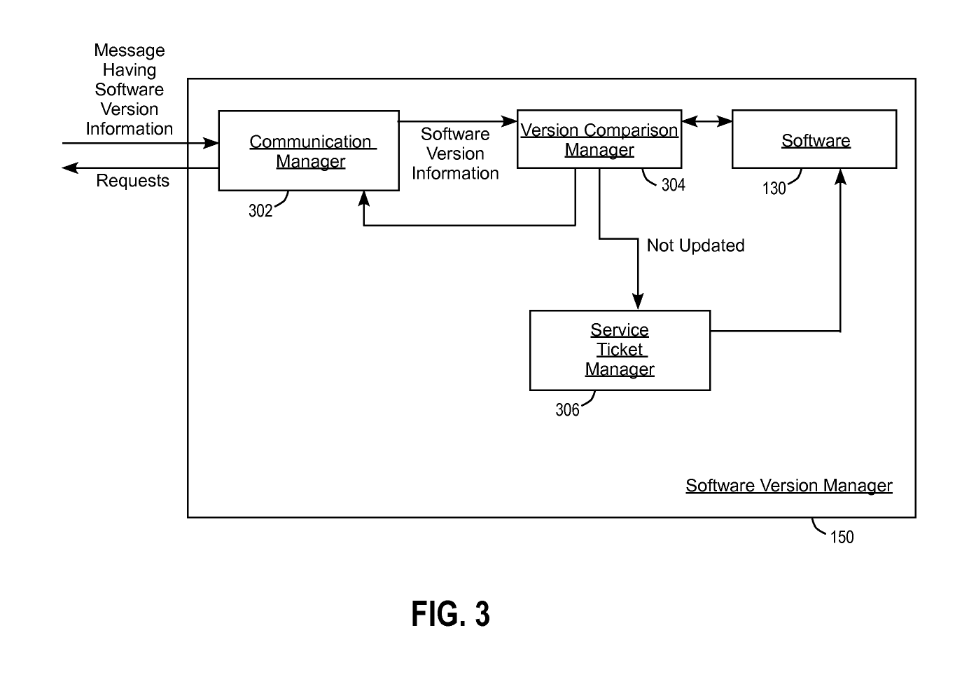

FIG. 3 depicts a more detailed example of software version manager 150 according to one embodiment. A communication manager 302 receives a message including the software version information. Communication manager 302 retrieves the software version information from the message, such as from an encrypted portion of the message. Communication manager 302 may determine the latest version in the software version information that is approved.

A version comparison manager 304 compares a current version of software 130 with versions included in the software version information. If the current version is included in the software version information, device 105 is allowed to retrieve key material for media and/or to access media from content server 110. Version comparison manager 304 notifies communication manager 302, which can then send requests for key material for media and/or media to content server 110. If the current version is not included in the software version information, a service ticket manager 306 inhibits device 105 from retrieving key material for media, and/or media from content server 110 until device 105 retrieves a latest version of software 130.

Upgrading of software versions is typically done at a user's will. There may not be a secure way of internally enforcing device 105 to upgrade to a latest version of software 130. This is essentially important if the upgrade was due to fixing a security breach in the system where high valued media content will be at stake that could compromise the entire security of the system. By binding the software upgrade to the service ticket, particular embodiments provide a way to trigger a software upgrade and hence a security upgrade. The trigger is performed on device 105 by causing device 105 not issue request to content server 110 until device 105 has retrieved a latest version of software 130. Device 105 does not have to send version information for software 130 to content server 110 in this case. That is, content server 110 offloads the trigger for software version checking from content server 110 to device 105. The offloading may free processing time from content server 110 and domain controller 112 when many different devices 105 of different types are requesting content.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations, and equivalents may be employed without departing from the scope of the invention as defined by the claims.

What is claimed is:

1. A method for enforcing a device software upgrade for software operable on a device, the method comprising:
receiving, at the device, a message including software-version information for the software from a domain controller, wherein the software-version information indicates a list of approved versions of the software;
determining, by the device, the software-version information from the message;
determining a current version of the software included on the device;
performing a comparison, by the device, of versions in the list of approved versions to the current version of the software on the device; and
if the current version of the software is not included in the list of approved versions, causing the device to not have or use a set of up-to-date security credentials for a set of content servers, for accessing any pieces of media on the set of content servers until the device has an approved version of the software.

2. The method of claim 1, further comprising if the current version of the software is included in the list of approved versions, receiving, at the device key material from at least one of content servers for at least one of the pieces of media.

3. The method of claim 1, further comprising obfuscating or alternatively protecting, by the device, the comparison of the versions in the list of approved versions to the current version of the software on the device.

4. The method of claim 1, further comprising retrieving, by the device, a new version of the software if the current version of the software is not included in the list of approved versions.

5. The method of claim 4, further comprising:
sending, by the device, a request to the domain controller for a set of updated security credentials if an approved version of the software has just been downloaded and installed; and
in response to sending the request, receiving the message including the updated security credentials.

6. The method of claim 4, further comprising:
sending, by the device, a request for a piece of media to at least one of the content servers based on retrieving the new version of the software; and
receiving, at the device, the piece of media from the at least one of the content servers.

7. The method of claim 1, further comprising prompting a user of the device to cause the device to retrieve the current version of the software.

8. The method of claim 1, wherein the software-version information includes versions for a plurality of approved device types authorized to retrieve media from the set of content servers.

9. The method of claim 1, wherein the software-version information is included in an encrypted or an authenticated portion of the message, the method further comprising decrypting the encrypted portion of the message or verifying the authenticated portion of the message to determine the list of approved versions in the software-version information.

10. A non-transitory computer-readable storage medium comprises instructions for enforcing a device software upgrade for software operable on a device, the instructions for controlling the device to be operable for:
receiving, at the device, a message including software-version information for the software from a domain controller, wherein the software-version information indicates a list of approved versions of the software;
determining, by the device, the software-version information from the message;
determining a current version of the software included on the device;
performing a comparison, by the device, of versions in the list of approved versions to the current version of the software on the device; and
if the current version of the software is not included in the list of approved versions, causing the device to not have or use a set of up-to-date security credentials for a set of content servers, for accessing any pieces of media on the set of content servers until the device has an approved version of the software.

11. The non-transitory computer-readable storage medium of claim 10, wherein if the current version of the software is included in the list of approved versions, the instructions are for further controlling the device to be operable for receiving, at the device key material from at least one of content servers for at least one of the pieces of media.

12. The non-transitory computer-readable storage medium of claim 10, wherein the instructions are for further controlling the device to be operable for obfuscating or alternatively protecting, by the device, the comparison of the versions in the list of approved versions to the current version of the software on the device.

13. The non-transitory computer-readable storage medium of claim 10, wherein the instructions are for further controlling the device to be operable for retrieving, by the device, a new version of the software if the current version of the software is not included in the list of approved versions.

14. The non-transitory computer-readable storage medium of claim 13, wherein the instructions are for further controlling the device to be operable for:
sending, by the device, a request to the domain controller for a set of updated security credentials if an approved version of the software has just been downloaded and installed; and
in response to sending the request, receiving the message including the updated security credentials.

15. The non-transitory computer-readable storage medium of claim 13, wherein the instructions are for further controlling the device to be operable for:
sending, by the device, a request for a piece of media to at least one of the content servers based on retrieving the new version of the software; and
receiving, at the device, the piece of media from the at least one of the content servers.

16. A device configured for enforcing a device software upgrade for software operable on the device, the device comprising:
one or more computer processors; and
a computer-readable storage medium comprises instructions for controlling the one or more computer processors to be operable for:
receiving, at the device, a message including software-version information for the software from a domain controller, wherein the software-version information indicates a list of approved versions of the software;
determining, by the device, the software-version information from the message;
determining a current version of the software included on the device;
performing a comparison, by the device, of versions in the list of approved versions to the current version of the software on the device; and
if the current version of the software is not included in the list of approved versions, causing the device to not have or use a set of up-to-date security credentials for a set of content servers, for accessing any pieces of media on the set of content servers until the device has an approved version of the software.

17. The device of claim 16, wherein if the current version of the software is included in the list of approved versions the instructions are for further controlling the one or more computer processors to be operable for receiving, at the device key material from at least one of content servers for at least one of the pieces of media.

18. The device of claim 16, wherein the instructions are for further controlling the one or more computer processors to be operable for obfuscating or alternatively protecting, by the device, the comparison of the versions in the list of approved versions to the current version of the software on the device.

19. The device of claim 16, wherein the instructions are for further controlling the one or more computer processors to be operable for retrieving, by the device, a new version of the software if the current version of the software is not included in the list of approved versions.

20. The device of claim 19, wherein the instructions are for further controlling the one or more computer processors to be operable for:
sending, by the device, a request to the domain controller for a set of updated security credentials if an approved version of the software has just been downloaded and installed; and
in response to sending the request, receiving the message including the updated security credentials.

21. A method for a server triggering a device software upgrade for software operable on the device, the method comprising:
receiving, at the server, a first message from the device;
transmitting, from the server, a second message including software-version information for the software to the device based on receiving the first message, wherein the software-version information includes a list of approved versions of the software; and
receiving, at the server, a request for an updated security credential for accessing a content server for retrieving a piece of media if one of the approved versions in the list of approved versions did not match a current version of the software on the device, and the software on the device was upgraded subsequently to one of the approved versions.

22. The method of claim 21, further comprising:
changing a security credential to the updated security credential, by the server, which is required for accessing the content server, if the client software on the device is to be changed and a new version is assigned to the software on the device;
receiving, at the server, the first message from the device based on the device being denied access to the content server via use, by the device, of the security credential that does not match the updated security credential.
